(19) United States
(12) Patent Application Publication
(10) Pub. No.: US 2022/0392267 A1
(43) Pub. Date: Dec. 8, 2022

(54) UPDATE METHOD FOR FACE DATABASE, AND FACE RECOGNITION METHOD, APPARATUS AND SYSTEM

(71) Applicant: BEIJING BAIDU NETCOM SCIENCE TECHNOLOGY CO., LTD., Beijing (CN)

(72) Inventors: Xin LI, Beijing (CN); Shengzhao WEN, Beijing (CN); Haocheng FENG, Beijing (CN)

(73) Assignee: BEIJING BAIDU NETCOM SCIENCE TECHNOLOGY CO., LTD., Beijing (CN)

(21) Appl. No.: 17/820,588

(22) Filed: Aug. 18, 2022

(30) Foreign Application Priority Data
Jan. 28, 2022 (CN) 2022101093949

(51) Int. Cl. G06V 40/50; G06V 10/74; G06V 40/16

(52) U.S. Cl. CPC G06V 40/50; G06V 10/761; G06V 40/172

(57) ABSTRACT

An update method for a face database, and a face recognition method, an apparatus and a system, including: obtaining a face image set belonging to a same user as an obtained current face image in an original face database, where the face database includes a face image set of at least one user, and the face image set includes a stored face image; determining similarity between the current face image and the stored face image of the same user, where there is a count value for the stored face image of the same user, and the count value represents a number of consecutive unsuccessful matches or consecutive successful matches between the stored face image of the same user and a further face image of the same user; and updating the original face database according to the similarity and the count value.

### CROSS-REFERENCE TO RELATED DISCLOSURE

This application claims priority to Chinese Patent Application No. 202210109394.9, filed on Jan. 28, 2022, which is hereby incorporated by reference in its entirety.

### TECHNICAL FIELD

The present disclosure relates to the field of artificial intelligence technology, specifically to the field of deep learning and computer vision technology, and can be applied to application scenarios such as face recognition, face image processing, etc., and in particular relates to an update method for a face database, and a face recognition method, an apparatus and a system.

### BACKGROUND

Face recognition technology is widely used in many scenarios, such as payment, security, access control, attendance, etc., and a face database is a significant factor to support realization of face recognition technology.

In order to make face recognition to be of relatively high accuracy and reliability, it is usually necessary to update the face database, for example, to update the face database based on a time interval.

However, there is a problem of low reliability in use of the time interval to update the face database.

### SUMMARY

The present disclosure provides an update method for a face database, and a face recognition method, an apparatus and a system.

According to a first aspect of the present disclosure, an update method for a face database is provided, including:

obtaining a face image set belonging to a same user as an obtained current face image in an original face database, where the face database includes a face image set of at least one user, and the face image set includes a stored face image;

determining similarity between the current face image and the stored face image of the same user, where there is a count value for the stored face image of the same user, and the count value represents a number of consecutive unsuccessful matches or consecutive successful matches between the stored face image of the same user and a further face image of the same user; and

updating the original face database according to the similarity and the count value to obtain an updated face database.

According to a second aspect of the present disclosure, a face recognition method is provided, including:

obtaining a face image to be recognized; and

recognizing the face image to be recognized based on a face database to obtain a recognizing result, where the face database is obtained based on the method described in the first aspect.

According to a third aspect of the present disclosure, an electronic device is provided, including:

at least one processor; and

a memory communicably connected with the at least one processor; where,

the memory stores an instruction executable by the at least one processor, and the instruction is executed by the at least one processor to enable the at least one processor to execute the method described in the first aspect; or, to enable the at least one processor to execute the method described in the second aspect.

According to a fourth aspect of the present disclosure, a non-transitory computer readable storage medium storing a computer instruction is provided, where the computer instruction is used to enable a computer to execute the method according to the first aspect; or, the computer instruction is used to enable the computer to execute the method according to the second aspect.

It should be understood that what is described in the present section is not intended to identify key or important features of embodiments of the present disclosure, nor is it intended to limit scope of the present disclosure. Other features of the present disclosure will become easily understood through following descriptions.

### BRIEF DESCRIPTION OF DRAWINGS

The drawings are for better understanding of the present solution and do not constitute a limitation on the present disclosure. Among them:

FIG. 1 is a schematic diagram according to a first embodiment of the present disclosure.

FIG. 2 is a schematic diagram according to a second embodiment of the present disclosure.

FIG. 3 is a schematic diagram of a scenario in which an update method for a face database can be implemented according to an embodiment of the present disclosure.

FIG. 4 is a schematic diagram according to a third embodiment of the present disclosure.

FIG. 5 is a schematic diagram according to a fourth embodiment of the present disclosure.

FIG. 6 is a schematic diagram according to a fifth embodiment of the present disclosure.

FIG. 7 is a schematic diagram according to a sixth embodiment of the present disclosure.

FIG. 8 is a schematic diagram according to a seventh embodiment of the present disclosure.

FIG. 9 is a block diagram of an electronic device used to implement an update method of face database and a face recognition method according to an embodiment of the present disclosure.

### DESCRIPTION OF EMBODIMENTS

Exemplary embodiments of the present disclosure are described below in combination with the drawings, where various details of the embodiments of the present disclosure are included to facilitate understanding, which should be considered as merely exemplary. Therefore, it should be recognized by persons of ordinary skilled in the art that various changes and modifications may be made to the embodiments described herein without departing from scope and spirit of the present disclosure. Similarly, for the sake of clarity and conciseness, descriptions of well-known functions and structures are omitted in the following description.

A face recognition technology refers to use of computer technology for analysis and comparison to recognize a face, including a face tracking and detection technology, an automatic adjustment technology of image amplification, a night infrared detection technology, an automatic adjustment technology of exposure intensity, etc. The face recognition technology is widely used in payment, security, access control, attendance and other scenarios. The face database is a significant factor to support realization of the face recognition technology.

For example, a face recognition system includes a face database where a face image is stored. In order to distinguish the face image stored in the face database from a subsequent acquired face image (such as a face image used to update the face database), the face image stored in the face database are called a stored face image, i.e., the face database includes the stored face image.

Taking a scenario where the face recognition technology is applied to access control as an example, when a user needs to pass through an access control, a face recognition system may obtain the user's face image. In order to distinguish the face image from a stored face image, the face image obtained by the face recognition system when the user needs to pass through the access control is called a current face image. The face recognition system matches the current face image with the stored face image, obtains a matching result, and determines whether the user can pass through the access control based on the matching result.

For example, if the matching result represents that the current face image and the stored face image belong to a same user, it is determined that the user can pass through the access control; on the contrary, if the matching result represents that the current face image and the stored face image do not belong to a same user, it is determined that the user cannot pass through the access control.

Based on the above analysis, it can be seen that the face database is a significant factor to support the realization of the face recognition, and accuracy and reliability of the face database determine reliability of the face recognition to a great extent.

As a user grows older, changes in weight, gets injured, gets dressed, or with a change of an angle or external light of the face recognition system or other conditions, the user's facial feature may change, i.e., the user's face image obtained by the face recognition system may change. Therefore, in order to make the face recognition to be of relatively high accuracy and reliability, it is usually necessary to update the face database.

In related technologies, following three methods are usually used to update the face database.

The first method includes: obtaining a number of times a user has been recognized and passed within a preset duration, and updating a face database according to the number of times the user has been recognized and passed within the preset duration, for example, reordering the user's face image features in the face database based on the number of times the user has been recognized and passed within the preset duration.

However, using the first method, although recognition speed can be improved by reordering, the face database is not updated in essence, resulting in a technical problem of low reliability of update.

The second method includes: obtaining a plurality of face images of a user within a preset time period, combining the plurality of face images to generate one face image, and comparing the face image with a respective face image in the face database, to make the face image be substituted into the face database.

However, using the second method, the face image is generated based on a combination of the plurality of face images, which is difficult to ensure authenticity of the image, and the image may deviate greatly from an actual face, resulting in the technical problem of the low reliability of the face database.

The third method includes: on the basis of the second method, in a process of combination, assigning weights to a respective face feature to update the face database based on the weights.

However, using the third method, in different scenarios and angles or other conditions, some face features are difficult to represent actual features of a user's face, which may therefore lead to the technical problem of the low reliability of the face database.

In order to avoid at least one of the above technical problems, inventors of the present disclosure obtained inventive concepts of the present disclosure through creative labor, including: determining similarity between a current face image and a stored face image, and updating a face database with the similarity and a count value of the stored face image, where the count value represents a number of consecutive unsuccessful matches or consecutive successful matches between the stored face image and a further face image.

Based on the above invention concepts, the present disclosure provides an update method for a face database, and a face recognition method, an apparatus and a system, which are applied in the field of artificial intelligence technology, specifically in the field of deep learning and computer vision technology, and can be applied to face recognition, face image processing or other application scenarios.

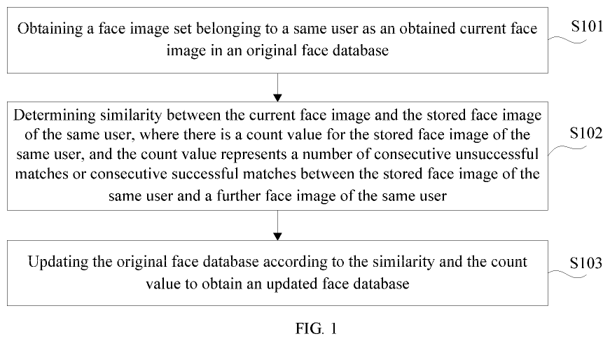

FIG. 1 is a schematic diagram according to a first embodiment of the present disclosure. As shown in FIG. 1, an update method for a face database in the embodiment of the present disclosure includes the following:

S101: obtaining a face image set belonging to a same user as an obtained current face image in an original face database.

The face database includes a face image set of at least one user, and the face image set includes a stored face image.

For example, an executing subject of the present embodiment may be an update apparatus for the face database (hereinafter referred to as the update apparatus), and the update apparatus may be a server (such as a cloud server, or a local server), a computer, a terminal device, a processor, a chip, etc., which is not limited in the present embodiment.

The “original” in the original face database is used to distinguish from an updated face database in the following, but should not be understood as a limitation on the face database.

Similarly, the current face image and the stored face image are relative concepts, and distinction between the two may refer to the above embodiments, which will not be repeated herein.

The original face database may include a face image set of one user or face image sets of a plurality of users, i.e., a user corresponds to a face image set, and the original face database may include a face image set or a plurality of face image sets.

A number of face image sets in the original face database varies based on different application scenarios, i.e., the number of face image sets in different application scenarios may be different.

For example, for an application scenario with relatively massive human traffic, the number of face image sets may be relatively large; on the contrary, for an application scenario with relatively small human traffic, the number of face image sets may be relatively small.

For example, taking an application scenario of access control as an example, and specifically taking an application scenario of access control in a residential area as an example, user capacities of different residential areas may be different, for example, user capacities of some residential areas are relatively large, then numbers of face image sets in corresponding face databases of the residential areas are relatively large; on the contrary, user capacities of some residential areas are relatively small, then numbers of face image sets in corresponding face databases of the residential areas are relatively small.

For another example, taking an application scenario of firm access control as an example, numbers of staffs in firms of different sizes may be different, and for a relatively large firm, a number of staffs in the firm is relatively large, then a number of face image sets in a corresponding face database of the firm is relatively large; on the contrary, for a relatively small firm, a number of staffs in the firm is relatively small, then a number of face image sets in a corresponding face database of the firm is relatively small.

It should be understood that the above description of the number of face image sets in the original face database in combination with application scenarios is only used to describe a condition that the number of face image sets may be more or less, but cannot be understood as a limitation on the number of face image sets.

Similarly, the present embodiment does not limit a number of the stored face image. For example, the number of the stored face image may be determined based on a memory capacity of the face database. For example, for a face database with a relatively large memory capacity, the number of the stored face image may be relatively large; on the contrary, for a face database with a relatively small memory capacity, the number of the stored face image may be relatively small. In other words, the number of the stored face image may be directly proportional to the memory capacity of the face database.

Moreover, it is worth noting that if the face database includes face image sets of a plurality of users, the number of the stored face image in the face image sets of different users may be the same or different.

For example, there are N (N is a positive integer greater than 1) face image sets in the face database, including a face image set 1, a face image set 2 and so on until a face image set N, then numbers of the stored face image in each of the N face image sets may be different, or numbers of the stored face image in some face image sets of the N face image sets may be the same, or the numbers of the stored face image in each of the N face image sets are the same.

For example, this step may be understood as follows:

the original face database includes a face image set, and when the update apparatus obtains the current face image, the face image set belonging to the same user as the current face image may be determined from the original face database, where a specific determination method is not limited in the present embodiment.

For example, the face image set belonging to the same user as the current face image may be determined based on similarity matching.

S102: determining similarity between the current face image and the stored face image of the same user.

There is a count value for the stored face image, and the count value represents a number of consecutive unsuccessful matches or consecutive successful matches between the stored face image and a further face image.

Accordingly, there is a count value for the stored face image of the same user, and the count value represents a number of consecutive unsuccessful matches or consecutive successful matches between the stored face image of the same user and a further face image of the same user.

In combination with the above analysis, it can be seen that a number of a stored face image in a face image set may be one or more. If a number of the stored face image in the face image set belonging to the same user as the current face image is one, similarity between the current face image and the stored face image in the face image set is determined; and if the number of the stored face image in the face image set is multiple, similarity between the current face image and each of the stored face image in the face image set is determined.

For example, in combination with the above embodiments, if the current face image and the face image set 1 belong to a same user (for the sake of description, this user is called a target user), and the face image set 1 includes m (m is a positive integer greater than 1) stored face images, including a stored face image 1, a stored face image 2 and so on until a stored face image m, this step may be understood as follows:

similarity between the current face image and the stored face image 1 is determined, for the convenience of distinguishing, the similarity is called similarity S1; similarity between the current face image and the stored face image 2 is determined, similarly, for the convenience of distinguishing, the similarity is called similarity S2; and so on until similarity between the current face image and the stored face image m is determined, similarly, for the convenience of distinguishing, the similarity is called similarity Sm.

It is worth noting that in the present embodiment, there is a count value for each stored face image. Taking the stored face image 1 as an example, there is a count value for the stored face image 1, and the count value may be a number of consecutive unsuccessful matches between the stored face image 1 and a further face image of the target user, or the count value may also be a number of consecutive successful matches between the stored face image 1 and the further face image of the target user.

The further face image of the target user may include the stored face image 2 and so on until the face image m; or the further face image of the target user may also include the stored face image 2 and so on until the face image m, and include a face image of the target user which is not stored in the face image set 1.

If the further face image of the target user includes the stored face image 2 and so on until the face image m, the count value of the stored face image 1 may be understood as follows:

if the stored face image 1 and the stored face image 2 do not match successfully, the count value is set to 1; if the stored face image 1 and a stored face image 3 do not match successfully, the count value may be accumulated, for example, by adding 1 to the count value 1; if the stored face image 1 and a stored face image 4 match successfully, the count value is cleared; and by analogy, the number of the consecutive unsuccessful matches between the stored face image 1 and the further face image of the target user is obtained;

or,

if the stored face image 1 and the stored face image 2 match successfully, the count value is set to 1; if the stored face image 1 and the stored face image 3 match successfully, the count value may be accumulated, for example, by adding 1 to the count value 1; if the stored face image 1 and the stored face image 4 do not match successfully, the count value is cleared; and by analogy, the number of the consecutive successful matches between the stored face image 1 and the further face image of the target user is obtained.

In a practical application scenario, a counter may be configured for each stored face image to determine a count value of the stored face image based on the counter; or, a counter may also be configured for each face image set, for example, a face image set corresponds to a counter, and corresponding count values of respective stored face images in the face image set are determined based on the counter; or, a counter may also be configured for each face database, for example, a face database corresponds to a counter, and corresponding count values of respective stored face images in the face database are determined based on the counter, etc., which is not limited in the present embodiment.

S103: updating the original face database according to the similarity and the count value to obtain an updated face database.

In combination with the above examples, it can be seen that the count value may represent a number of consecutive unsuccessful matches (or a number of consecutive successful matches), and by updating the original face database with the similarity and the number of the consecutive unsuccessful matches (or the number of the consecutive successful matches), relatively speaking, update of the original face database can be controlled as a whole, so as to achieve a technical effect of reliability and accuracy of the update.

Based on the above analysis, the embodiment of the present disclosure provides an update method for a face database, including: obtaining, in an original face database, a face image set belonging to a same user as an obtained current face image, where the face database includes a face image set of at least one user, and the face image set includes a stored face image; determining similarity between the current face image and the stored face image of the same user, where there is a count value for the stored face image of the same user, and the count value represents a number of consecutive unsuccessful matches or consecutive successful matches between the stored face image of the same user and a further face image of the same user; and updating the original face database according to the similarity and the count value to obtain an updated face database. In the present embodiment, by determining the similarity between the current face image and the stored face image of the same user, with a technical feature that a updating process is performed by combining the similarity with the count value of the stored face image of the user, and based on the number of the consecutive unsuccessful matches or the number of the consecutive successful matches of each stored face image of the same user, comprehensiveness and integrity of the update process is achieved, so as to achieve the technical effect of improving the accuracy and the reliability of updating the original face database.

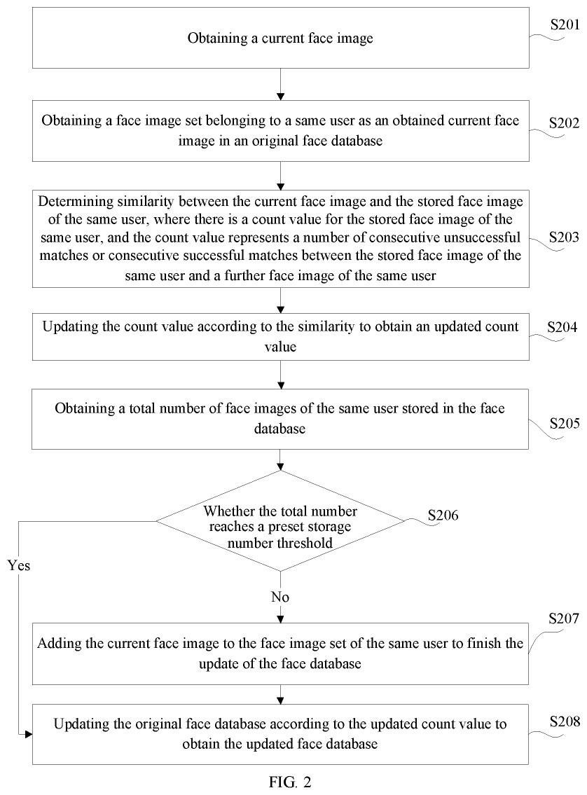

FIG. 2 is a schematic diagram according to a second embodiment of the present disclosure. As shown in FIG. 2, an update method for a face database in the embodiment of the present disclosure includes the following.

S201: obtaining a current face image.

It can be understood that in order to avoid redundancy, the present embodiment will not repeat same technical features as the above embodiment.

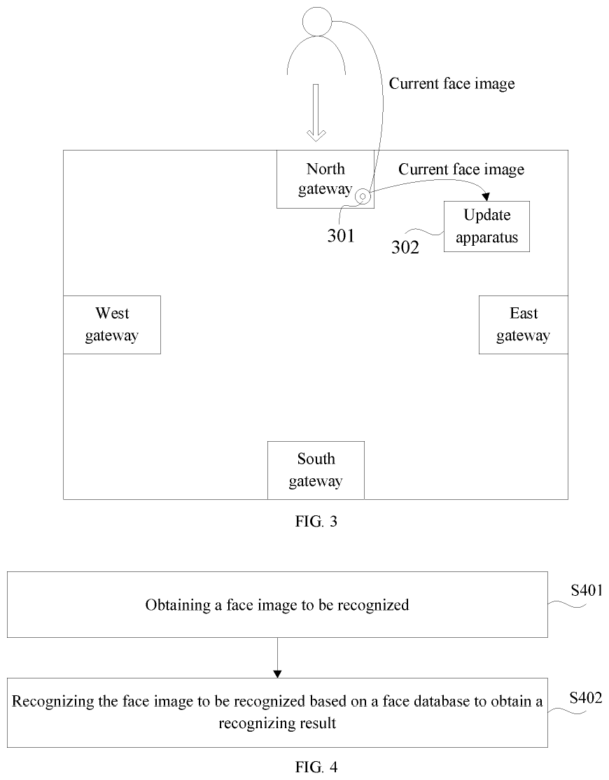

In combination with the above embodiments, it can be seen that the method in the present embodiment may be applied to an application scenario of access control in a residential area. As shown in FIG. 3, a residential area includes a plurality of different gateways, such as a north gateway, a south gateway, a west gateway and an east gateway as shown in FIG. 3.

In an example, each gateway is provided with a gate for entering and exiting the residential area, and each gate may be provided with a face recognition system, where each face recognition system includes a face database, and accordingly, each face recognition system includes an update apparatus.

In another example, based on the above example, each face recognition system shares one update apparatus, or each face recognition system shares one face database, i.e., the one face database is created, and the one face database is updated by the one update apparatus.

In other embodiments, each gateway is provided with a gate for entering and exiting the residential area, and each gate shares one face recognition system, where the face recognition system includes a face database, and accordingly, the face recognition system includes an update apparatus, or the face recognition system and the update apparatus are two mutually independent devices.

In other words, the face recognition system and the update apparatus may be an integrated device, or mutually independent devices; numbers of the face recognition system and the update apparatus may be the same or different; the face database may be a storage device that is independent from the face recognition system or a storage device integrated into the face recognition system; and a number of the face database may be the same as a number of the face recognition system, or different from the number of the face recognition system, etc.

Taking a user entering the north gateway as an example, an implementation principle of S201 may refer to following description:

a gate is provided at the north gateway, and an image acquisition apparatus is provided at the gate, such as a camera 301, etc. When a user enters the north gateway, the camera 301 may acquire the user's face image (i.e., the current face image).

The camera 301 may be connected with an update apparatus 302 and transmit the acquired current face image to the update apparatus 302, and accordingly, the update apparatus 302 obtains the current face image.

S202: obtaining a face image set belonging to a same user as an obtained current face image in an original face database.

The face database includes a face image set of at least one user, and the face image set includes a stored face image.

In combination with the above embodiment, the update apparatus may determine a face image set corresponding to the user entering the north gateway from N face image sets in the face database.

The number of the face database may be multiple, for example, each of the north gateway, the south gateway, the west gateway and the east entrance corresponds to one face database; or, at least two of the gateways share one face database; or, the north gateway, the south gateway, the west gateway and the east gateway share one face database.

In some embodiments, the face image set may be a face image feature set, and the face image feature set includes a face image feature. For example, in the face database, a user identifier ID is assigned to each user, and the user's face image feature are stored with each user ID.

Accordingly, S202 may be implemented in following manners.

Manner 1:

obtaining a current face image feature of the current face image; for each user identifier, matching the current face image feature with each stored face image feature with each user identifier to obtain a respective matching result; and determining a face image feature set belonging to the same user as the current face image feature according to the respective matching result.

For example, in combination with the above embodiments, the user entering the north gateway is called a current user. After obtaining the current face image of the current user, feature extraction can be performed on the current face image to obtain the current face image feature of the current user. The current face image feature is used to represent an appearance feature of the current user's face.

The face database includes face image feature sets with user identifiers from 1 to N, and a face image feature set with a user identifier 1 is a face image feature set 1, and by analogy, a face image feature set with a user identifier N is a face image feature set N.

For the face image feature set 1 with the user identifier 1, the update apparatus matches the current face image feature with each stored face image feature in the face image feature set 1 to obtain a matching result. If the face image feature set 1 includes m stored face image features, m matching results are obtained.

In some embodiments, by analogy, matching results between the current face image feature and each of N face image feature sets are obtained, and a face image feature set with a best matching result is selected and is determined as the face image feature set belonging to the same user as the current face image feature, i.e., the face image feature set of the current user in the face database is determined.

The best matching result may be a matching result with maximum similarity represented thereby, or a maximum number of matching results with similarity that is represented by a matching result and greater than a preset threshold.

Take the matching result with the maximum similarity represented thereby as an example:

there is a matching result between the current face image feature and each stored face image feature in each of the N face image feature sets. The matching result with the maximum similarity is determined from all the matching results, and a face image feature set corresponding to the matching result is determined, so as to determine the face image feature set as the face image feature set belonging to the current user.

Take the maximum number of matching results with similarity that is represented by a matching result and greater than a preset threshold as an example:

there is a matching result between the current face image feature and each stored face image feature in each of the N face image feature sets. For each face image feature set, a number of stored face image features whose similarity represented by a matching result is greater than the preset threshold is calculated, and a face image feature set with a largest number is selected from the N face image feature sets, and the face image feature set is determined as the face image feature set belonging to the current user.

Manner 2:

obtaining a current face image feature of the current face image; for each user identifier, determining a stored face image feature with the user identifier, and performing a weighted processing to obtain a weighted feature with the user identifier; matching the current face image feature with the weighted feature with each user identifier to obtain a respective matching result; and according to the respective matching result, determining the face image feature set belonging to the same user as the current face image feature.

Similarly, in combination with the above embodiments, the user entering the north gateway is called a current user. After obtaining the current face image of the current user, the current face image feature may be extracted to obtain a current face image feature of the current user. The current face image feature is used to represent an appearance feature of the current user's face.

The face database includes face image feature sets with user identifiers from 1 to N, and a face image feature set with the user identifier 1 is a face image feature set 1, and by analogy, a face image feature set with user identifier N is a face image feature set N.

Accordingly, weighted feature 1 of each stored face image feature in the face image set 1 is calculated, and so on until weighted feature N of each stored face image feature in the face image set N is obtained.

Similarity matching between the current face image feature and the weighted feature 1 is performed to obtain a matching result, and so on until a matching result between the current face image feature and the weighted feature N is obtained, and a matching result with a maximum similarity represented thereby is determined from N matching results. A face image feature set corresponding to the matching result is determined as the face image feature set belonging to the same user as the current face image feature.

For a weighted feature of any face image feature set, the weighted feature may be a facial feature obtained by performing a weighed approach on each stored face image feature in the any face image feature set and used to represent a user corresponding to the any face image feature set.

It should be understood that the above embodiments are only used to exemplarily describe how to determine the face image set belonging to the same user as the current face image, but cannot be understood as a limitation on determining the face image set belonging to the same user as the current face image.

It is worth noting that by using manner 1 or manner 2 as described in the above embodiments to determine the face image set of the same user, a technical effect of flexibility and diversity of determining the face image set of the same user can be achieved.

S203: determining similarity between the current face image and the stored face image of the same user.

There is a count value for the stored face image of the same user, and the count value represents a number of consecutive unsuccessful matches or consecutive successful matches between the stored face image of the same user and a further face image of the same user.

S204: updating the count value according to the similarity to obtain an updated count value.

Since the count value may be represented in two different dimensions, in order to facilitate a reader's understanding, we describe an update process in two different dimensions.

Taking the count value representing the number of the consecutive unsuccessful matches as an example:

if the similarity is less than a preset similarity threshold, the count value is accumulated to obtain the updated count value; and if the similarity is greater than the similarity threshold, the count value is cleared to obtain the updated count value.

The similarity threshold may be determined based on a demand, a historical record, an experiment or other manners, which is not limited in the present disclosure.

For example, if the similarity threshold is determined by the demand, the similarity threshold may be set to a relatively large value for a relatively high demand; on the contrary, for a relatively low demand, the similarity threshold may be set to a relatively small value.

In combination with the above embodiments, an accumulating process may be plus 1. For example, the count value of the stored face image 1 is 6 (i.e., the number of the consecutive unsuccessful matches is 6). If the similarity between the current face image and the stored face image 1 is greater than the similarity threshold, the count value of the stored face image 1 is cleared to obtain an updated count value 0 of the stored face image 1.

On the contrary, if the similarity between the current face image and the stored face image 1 is less than the similarity threshold, the count value of the stored face image 1 is added by 1 to obtain an updated count value 7 of the stored face image 1.

In the present embodiment, by analyzing a size relationship between the similarity and the similarity threshold to update the count value in different manners (i.e. an accumulating process or a clearing process) under different conditions, a technical effect of effectiveness and reliability of the update can be achieved.

Taking the count value representing the number of the consecutive successful matches as an example:

if the similarity reaches a preset similarity threshold, the count value is accumulated to obtain the updated count value; and if the similarity is less than the similarity threshold, the count value is cleared to obtain the updated count value.

Similarly, an accumulating process may be plus 1. For example, the count value of the stored face image 1 is 6 (i.e., the number of the consecutive successful matches is 6). If the similarity between the current face image and the stored face image 1 is greater than the similarity threshold, the count value of the stored face image 1 is added by 1 to obtain an updated count value 7 of the stored face image 1.

On the contrary, if the similarity between the current face image and the stored face image 1 is less than the similarity threshold, the count value of the stored face image 1 is cleared to obtain an updated count value 0 of the stored face image 1.

In the present embodiment, by analyzing a size relationship between the similarity and the similarity threshold to update the count value in different manners (i.e. an accumulating process or a clearing process) under different conditions, and a technical effect of effectiveness and reliability of the update can be achieved.

It is worth noting that the updated count value may be used as an initial count value for a next update of the face database, so as to update the updated face database on the basis of the count value.

S205: obtaining a total number of face images of the same user that are stored in the face database.

For example, in combination with the above embodiments, if the face image set of the same user is the face image set 1, a total number of face images stored in the face image set 1 is obtained.

S206: determining whether the total number reaches a preset storage number threshold: if not, executing S207; and if so, executing S208.

For example, there is a certain size for a storage space of the face database, and a number of face images that can be stored in the face database is limited. And in order to avoid low efficiency of face recognition, the number of the face images stored in the face database should not be too large. Therefore, an upper limit of the face images that can be stored in the face database (i.e., the storage number threshold) may be set in advance, and an upper limit value of each user's face image may be further set.

For example, for each user's face image set, an upper limit of the face images that can be stored in the face image set is 10, i.e., the face image set may include up to 10 stored face images.

In other words, the storage number threshold may be determined based on the storage space of the face database, or based on recognition efficiency, or of course, based on other manners, which are not listed herein.

S207: adding the current face image to the face image set of the same user to finish the update of the face database.

In combination with the above analysis, this step may be understood as follows: if the total number of the same user has not reached the storage number threshold, the current face image may be directly added to the face image set of the same user, and so far, the update of the face database ends.

For example, in combination with the above embodiments, if the face image set of the same user is the face image set 1, the storage number threshold of the face image set of the same user is 10 (i.e., a number of stored face images of the face image set 1 that can be stored in the face database is 10), and a number of stored face images in the face image set 1 is 6, the current face image may be added to the face image set 1. Thus, an update of the face image set 1 is finished, and then the update of the face database is updated.

In the present embodiment, when the total number does not reach the storage number threshold, the current face image is stored in the face image set of the same user to update the face database, which enables the face image set to include as many face images used to represent the user's facial feature as possible, so as to improve reliability and effectiveness of recognition.

S208: updating the original face database according to the updated count value to obtain the updated face database.

In combination with the above embodiments, it can be seen that the count value may be represented in two different dimensions, and accordingly, the updated count value may also be represented in two different dimensions. For example, the updated count value may represent an updated number of consecutive unsuccessful matches, or an updated number of consecutive successful matches. Now this step is exemplarily described in two different dimensions respectively.

If the updated count value represents the updated number of the consecutive unsuccessful matches, S208 may include following steps:

Step 1: determining a maximum updated count value from each updated count value.

Step 2: replacing a stored face image with the maximum updated count value with the current face image.

For example, in combination with the above embodiments, if the face image set of the same user is the face image set 1, the storage number threshold of the face image set of the same user is 10 (i.e., a number of stored face images of the face image set 1 that can be stored in the face database is 10), and a number of stored face images in the face image set 1 is 10 (i.e., the total number of the face image set 1 has reached the storage number threshold), and there is an updated count value for each face image in the face image set 1, i.e., the updated number of the consecutive unsuccessful matches, a maximum updated number of the consecutive unsuccessful matches is determined from 10 updated count values.

After determining the maximum updated number of the consecutive unsuccessful matches, a stored face image corresponding to the determined maximum updated number of the consecutive unsuccessful matches is replaced with the current face image. For example, the stored face image corresponding to the determined maximum updated number of the consecutive unsuccessful matches is deleted from the face image set 1, and the current face image is added to the face image set 1, to realize the update of the face image set 1, and then the update of the face database is realized.

In the present embodiment, by replacing the stored face image corresponding to the maximum updated number of the consecutive unsuccessful matches, it is possible to remove a face image of a relatively low quality from the face image set, i.e., remove the face image of the relatively low quality from the face database, and store a face image of a relatively high quality into the face image set, i.e., add the face image of the relatively high quality to the face database, to realize the update of the face database, which can improve reliability and effectiveness of the update of the face database, and then improve the reliability and the accuracy of the face recognition.

In some embodiments, in order to further improve the reliability and the effectiveness of the update of the face database, after determining the maximum updated number of consecutive unsuccessful matches, a size relationship between the maximum updated number of consecutive unsuccessful matches and a threshold of consecutive unsuccessful matches may be further determined, for example, whether the maximum updated number of consecutive unsuccessful matches reaches the threshold of the consecutive unsuccessful matches is determined, if so, the stored face image with the maximum updated number of the consecutive unsuccessful matches is replaced with the current face image; otherwise, the face database will not be adjusted temporarily.

Similarly, the threshold of the consecutive unsuccessful matches may be determined based on a demand, a historical record, an experiment or other manners, which is not limited in the present disclosure.

In the present embodiment, by updating the face database with the threshold of the consecutive unsuccessful matches, a disadvantage of removing a face image of high quality from the face database can be avoided, so as to achieve the technical effect of improving the reliability and the accuracy of the update.

If the updated count value represents the updated number of the consecutive successful matches, S208 may include: if there is an updated count value of zero, replacing a stored face image with the updated count value of zero with the current face image.

For example, in combination with the above embodiments, if the face image set of the same user is the face image set 1, the storage number threshold of the face image set of the same user is 10 (i.e., a number of stored face images of the face image set 1 that can be stored in the face database is 10), and a number of stored face images in the face image set 1 is 10 (i.e., the total number of the face image set 1 has reached the storage number threshold), and there is an updated count value for each face image in the face image set 1, i.e., the updated number of the consecutive successful matches, whether there is an updated number of consecutive successful matches being zero is determined in 10 updated count values.

In some embodiments, if there is the updated number of the consecutive successful matches being zero, a stored face image with the updated count value of zero is replaced with the current face image.

In other word, after determining the updated number of the consecutive successful matches being zero, the stored face image corresponding to the updated number of the consecutive successful matches being zero is replaced with the current face image. For example, the stored face image corresponding to the updated number of the consecutive successful matches being zero is deleted from the face image set 1, and the current face image is added to the face image set 1, to realize the update of the face image set 1, and then the update of the face database is realized.

In the present embodiment, by replacing the stored face image of the updated count value of zero with the current face image to update the face database, relatively speaking, a stored face image that is most inconsistent with a face feature of the same user can be removed and replaced with the current face image that is relatively more representative of the face feature of the same user, so as to achieve the technical effect of improving the reliability and the accuracy of the update.

There may be a plurality of updated numbers of consecutive successful matches being zero, or there may be one updated number of the consecutive successful matches being zero. If there is one updated number of the consecutive successful matches being zero, a stored face image with the updated count value of zero is replaced with the current face image.

If there is the plurality of updated numbers of the consecutive successful matches being zero, an updated count value of zero with a maximum number of clearing is determined from a plurality of updated count values of zero, and a stored face image of the updated count value of zero with the maximum number of the clearing is replaced with the current face image.

For example, in combination with the above embodiments, the face image set 1 includes 10 stored face images, and 3 of 10 updated numbers of consecutive successful matches are zero, then a stored face image corresponding to an updated number of consecutive successful matches being zero with a maximum number of clearing is determined in the 3 updated numbers of the consecutive successful matches being zero, and the stored face image is removed from the face database, and the current face image is added to the face database, to update the face database.

In the present embodiment, by replacing the stored face image with the updated count value of zero with the maximum number of the clearing with the current face image, relatively speaking, a stored face image most weakly representing the facial feature of the same user can be removed from the face database, and the current face image that can relatively strongly representing the facial feature of the same user is added, so as to achieve the reliability and the effectiveness of the update of the face database, and then a technical effect of accuracy and reliability of the face recognition is achieved.

In other embodiments, if there is no updated number of the consecutive successful matches being zero, a number of clearing of a count value of each stored face image of the same user is determined, and a stored face image corresponding to a maximum number of clearing is replaced with the current face image; or, a minimum number is determined in the respective updated number of consecutive successful matches, and a stored face image corresponding to the minimum number may be replaced with the current face image.

Based on the above analysis, it can been seen that the updated count value may be used as an initial count value for a next update of the face database, so as to update the updated face database on the basis of the count value. Accordingly, after replacing the stored face image with the current face image and adding the current face image into the face database, a count value of the current face image may be set, and the count value is set to 0, so as to update the face database again with the count value.

In some embodiments, when updating the original face database with the updated count value, the original face database may be updated in combination with storage time of the stored face image of the same user and the updated count value.

For example, in combination with the above embodiments, there is a time stamp for the respective stored face image in the face image set 1, and the time stamp is used to represent time when the stored face image is stored in the face database, and a weight is assigned to the stored face image based on the time stamp of each stored face image in the face image set 1, so as to update the original face database based on weights of the respective stored face images in the face image set 1 and the updated count value.

The weight may be directly proportional to the time stamp, i.e., the longer the stored face image is stored in the face database, the greater a corresponding weight is. A product of the weight and the updated count value may be calculated, and the original face database may be updated based on the product.

It is worth noting that in the present embodiment, by determining the weight with the time stamp and updating the original face database with the weight, relatively speaking, a stored face image with previous storage time can be removed, and a stored face image relatively close to current time can be remained, so as to achieve the technical effect of the effectiveness and the reliability of the update of the face database.

FIG. 4 is a schematic diagram according to a third embodiment of the present disclosure. As shown in FIG. 4, a face recognition method of the embodiment in the present disclosure includes the following.

S401: obtaining a face image to be recognized.

For example, an executing subject in the present embodiment may be a face recognition apparatus, and the face recognition apparatus and the update apparatus in the above embodiments may be a same apparatus or different apparatuses, which is not limited in the present disclosure.

Following examples may be used to obtain the face image to be recognized.

In an example, the face recognition apparatus may be connected with an image acquisition apparatus and receive the face image to be recognized sent by the image acquisition apparatus.

In another example, the face recognition apparatus may provide an image loading tool, and a user may transmit the face image to be recognized to the face recognition apparatus through the image loading tool.

The image loading tool may be an interface used to connect with an external device, such as an interface used to connect with other storage devices, and the image transmitted by the external device is obtained through the interface; the image loading tool may also be a display apparatus, for example, the face recognition apparatus may input an interface of image loading function on the display apparatus, the user may import the face image to be recognized into the face recognition apparatus through the interface, and the face recognition apparatus obtains the imported face image to be recognized.

It is worth noting that an update of a face database and recognition of a face image may be realized at the same time, i.e., when the face database is updated, the face image may also be recognized, or when the face image is recognized, the face database may also be updated.

For example, taking the above application scenario of access control in a residential area as an example, when a current face image of a current user is obtained, the update method for the face database in the above embodiments may be executed, and the method for recognizing the current face image in the present embodiment may also be executed.

S402: recognizing the face image to be recognized based on a face database to obtain a recognizing result.

The face database is obtained based on the update method for the face database described in any of the above embodiments.

In combination with the above embodiments, this step may be understood as follows: the face image to be recognized is recognized based on the face database to determine whether a user of the face image to be recognized is a user of the residential area, to obtain the recognizing result.

For example, if the recognizing result represents that the user of the face image to be recognized is the user of the residential area, a gate of the residential area is controlled to open, and the user can enter the residential area; on the contrary, if the recognizing result represents that the user of the face image to be recognized is not the user of the residential area, the gate of the residential area is controlled to be in a closed state, i.e., the user cannot enter the residential area.

Based on the above analysis, it can be seen that due to high accuracy and reliability of the face database, when the face recognition is based on the face database, accuracy and reliability of the face recognition can be improved.

In some embodiments, S402 may include: determining, in the face database, whether there is a face image set belonging to a same user as the face image to be recognized, if so, the recognizing result represents that the user corresponding to the face image to be recognized is a user allowed to pass; if not, the recognizing result represents that the user corresponding to the face image to be recognized is a user not allowed to pass.

The method of determining whether there is a face image set belonging to a same user as the face image to be recognized from the face database is not limited in the present embodiment, which may be realized, for example, by similarity matching in the above embodiments, or through other manners.

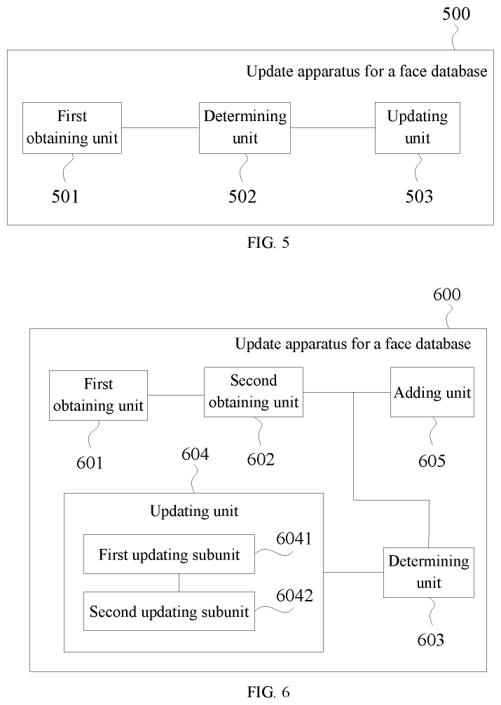

FIG. 5 is a schematic diagram according to a fourth embodiment of the present disclosure. As shown in FIG. 5, an update apparatus 500 for a face database in the embodiment of the present disclosure includes:

a first obtaining unit 501, configured to obtain a face image set belonging to a same user as an obtained current face image in an original face database, where the face database includes a face image set of at least one user, and the face image set includes a stored face image;

a determining unit 502, configured to determine similarity between the current face image and the stored face image of the same user, where there is a count value for the stored face image of the same user, and the count value represents a number of consecutive unsuccessful matches or consecutive successful matches between the stored face image of the same user and a further face image of the same user; and

an updating unit 503, configured to update the original face database according to the similarity and the count value to obtain an updated face database.

FIG. 6 is a schematic diagram according to a fifth embodiment of the present disclosure. As shown in FIG. 6, an update apparatus 600 for a face database in the embodiment of the present disclosure includes:

a first obtaining unit 601, configured to obtain a face image set belonging to a same user as an obtained current face image in an original face database, where the face database includes a face image set of at least one user, and the face image set includes a stored face image;

a second obtaining unit 602, configured to obtain a total number of face images of the same user stored in the face database;

a determining unit 603, configured to determine similarity between the current face image and the stored face image of the same user when the total number reaches a preset storage number threshold,

there is a count value for the stored face image of the same user, and the count value represents a number of consecutive unsuccessful matches or consecutive successful matches between the stored face image of the same user and a further face image of the same user;

an updating unit 604, configured to update the original face database according to the similarity and the count value to obtain an updated face database; and

an adding unit 605, configured to, when the total number does not reach the storage number threshold, add the current face image to the face image set of the same user.

In combination with FIG. 6, it can be seen that in some embodiments, the update unit 604 includes:

a first updating subunit 6041, configured to update the count value according to the similarity to obtain an updated count value; and

a second updating subunit 6042, configured to update the original face database according to the updated count value to obtain the updated face database.

In some embodiments, when the count value represents the number of the consecutive unsuccessful matches, the first updating subunit 6041 includes:

a first accumulating module, configured to, when the similarity is less than a preset similarity threshold, accumulate the count value and obtain the updated count value; and

a first clearing module, configured to, when the similarity is greater than the similarity threshold, clear the count value to obtain the updated count value.

In some embodiments, when the count value represents the number of the consecutive successful matches, the first updating subunit 6041 includes:

a second accumulating module, configured to, when the similarity reaches a preset similarity threshold, accumulate the count value to obtain the updated count value; and

a second clearing unit, configured to, when the similarity is less than the similarity threshold, clear the count value to obtain the updated count value.

In some embodiments, when the count value represents the number of the consecutive unsuccessful matches; a number of the stored face image of the same user is multiple, and there is an updated count value for each stored face image of the same user; the second updating subunit 6042 includes:

a first determining module, configured to determine a maximum updated count value from each updated count value; and

a first replacing module, configured to replace a stored face image with the maximum updated count value with the current face image.

In some embodiments, the first replacing module is configured to, when the maximum updated count value reaches a preset threshold of the consecutive unsuccessful matches, replace the stored face image with the maximum updated count value with the current face image.

In some embodiments, when the count value represents the number of the consecutive successful matches; a number of the stored face image of the same user is multiple, and there is an updated count value for each stored face image of the same user; the second updating subunit 6042 is configured to, when there is an updated count value of zero, replace a stored face image with the updated count value of zero with the current face image.

In some embodiments, the second updating subunit 6042 includes:

a second determining module, configured to, from the plurality of updated count values of zero, determine an updated count value of zero with a maximum number of clearing; and

a second replacing module, configured to replace a stored face image of the updated count value of zero with the maximum number of the clearing with the current face image.

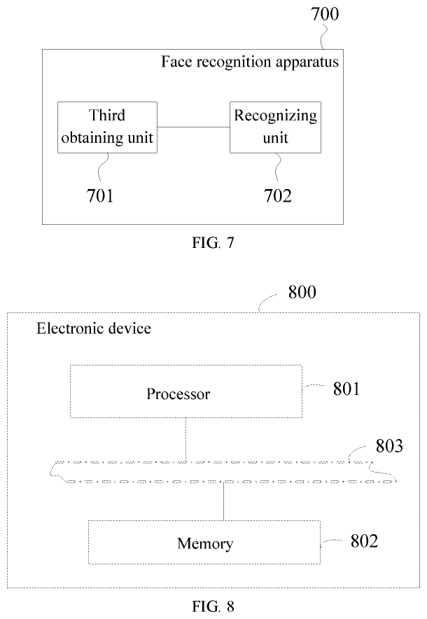

FIG. 7 is a schematic diagram according to a sixth embodiment of the present disclosure. As shown in FIG. 7, a face recognition apparatus 700 of the embodiment in the present disclosure includes:

a third obtaining unit 701, configured to obtain a face image to be recognized; and

a recognizing unit 702, configured to recognize the face image to be recognized based on a face database to obtain a recognizing result. Where the face database is obtained based on the update method for the face database described in any of the above embodiments.

According to another aspect of the embodiment in the present disclosure, the embodiments of the present disclosure further provide a face recognition system, including:

a face database, where the face database is obtained based on the update method for the face database described in any of the above embodiments;

a face recognition apparatus described in the above embodiments.

In other words, the embodiments of the present disclosure provide a face recognition system, and the system includes a face recognition apparatus and a face database, where the face recognition apparatus is configured to obtain a face image to be recognized, and recognize the face image to be recognized based on the face database, so as to obtain a recognizing result.

It is worth noting that the face database may be a storage device in the face recognition apparatus or a storage device independent from the face recognition apparatus, which is not limited in the present embodiment.

In some embodiments, the face recognition system further includes:

an image acquisition apparatus, configured to acquire a face image to be recognized.

The image acquisition apparatus may be a camera or other device with an image acquisition function.

Similarly, the image acquisition apparatus and the face recognition apparatus may be an integrated apparatus, or mutually independent apparatus, which is not limited in the present embodiment.

When the face recognition system of the present embodiment is applied to the application scenario as shown in FIG. 3, in an example, a face recognition apparatus may be provided at each gateway, i.e., four face recognition apparatuses are provided. The four face recognition apparatuses are connected with an update apparatus, and the update apparatus distributes an updated face database to each face recognition apparatus, so as to enable each face recognition apparatus to perform face recognition.

In this example, the face recognition apparatus at each gateway may share a face database to realize resource sharing, so as to save resources, and in combination with a user's access possibility, a relatively comprehensive and complete face database is established, which can achieve a technical effect of effectiveness and accuracy of recognition.

In another example, one face recognition apparatus and one face database are provided at each gateway, and each face recognition apparatus realizes face recognition based on a face database provided correspondingly.

In yet another example, each gateway is provided with an image acquisition apparatus, the respective image acquisition apparatus is connected with a face recognition apparatus, and the face recognition apparatus is connected with a face database, so as to enable the face recognition apparatus to perform face recognition on a user at each gateway.

It is worth noting that the above embodiments are only used to exemplarily describe possible forms of the image acquisition apparatus, the face database and the face recognition apparatus, but cannot be understood as a limitation on the image acquisition apparatus, the face database and the face recognition apparatus.

FIG. 8 is a schematic diagram according to a seventh embodiment of the present disclosure. As shown in FIG. 8, an electronic device 800 in the present disclosure may include: a processor 801 and a memory 802.

The memory 802 is configured to store a program; and the memory 802 may include a volatile memory (English: volatile memory), for example, a random-access memory (English: random-access memory, abbreviation: RAM), a static random access memory (English: static random-access memory, abbreviation: SRAM), a double data rate synchronous dynamic random access memory (English: double data rate synchronous dynamic random access memory, abbreviation: DDR SDRAM), etc.; and the memory may also include a non-volatile memory, such as a flash memory (English: flash memory). The memory 802 is configured to store a computer program (such as an application program, a functional module, etc. that realized the above methods), a computer instruction, etc., and the computer program and the computer instruction may be partitioned and stored in one or more memories 802. And the above computer program, the computer instruction, data, etc., may be called by the processor 801.

The above computer program, the computer instruction, etc., may be partitioned and stored in one or more memories 802. And the above computer program, the computer instruction, etc., may be called by the processor 801.

The processor 801 is configured to execute the computer program stored in the memory 802 to implement each step of the method involved in the above embodiments.

For details, please refer to relevant descriptions in the previous method embodiments.

The processor 801 and the memory 802 may be independent structures or an integrated structure. When the processor 801 and the memory 802 are independent structures, the memory 802 and the processor 801 may be coupled through a bus 803.

An electronic device of the present embodiment may implement a technical solution in the above method, and a specific implementation process and a technical principle thereof are the same, which are not repeated herein.

In the technical solution of the present disclosure, collection, storage, use, process, transmission, provision and disclosure of a user's personal information (such as a face image, etc.) comply with provisions of relevant laws and regulations, and do not violate public order and good custom.

According to the embodiments of the present disclosure, the present disclosure further provides an electronic device, a readable storage medium, and a computer program product.

According to the embodiments of the present disclosure, the present disclosure further provides a computer program product, and the computer program includes a computer program, where the computer program is stored in a readable storage medium, at least one processor of an electronic device may read the computer program from the readable storage medium, and the at least one processor executes the computer program to enable the electronic device to execute a solution provided by any of the above embodiments.

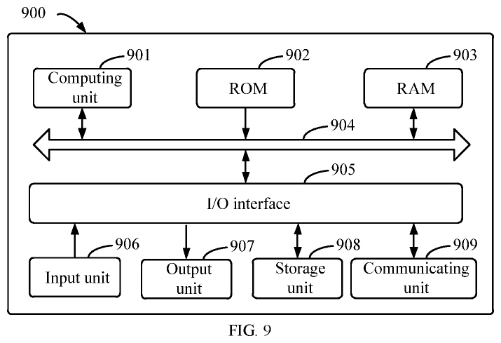

FIG. 9 shows a schematic block diagram of an exemplary electronic device 900 that may be used to implement the embodiments of the present disclosure. The electronic device is intended to represent various forms of digital computers, such as a laptop computer, a desktop computer, a workstation, a personal digital assistant, a server, a blade server, a mainframe computer, or other suitable computers. The electronic device may also represent various forms of mobile apparatuses, such as a personal digital assistant, a cellular phone, a smart phone, a wearable device, or other similar computing apparatuses. Components shown herein, connections and relationships thereof, and functions thereof are merely examples, which are not intended to limit an implementation of the present disclosure described and/or claimed herein.

As shown in FIG. 9, the electronic device 900 includes a computing unit 901, which may perform various appropriate actions and processes according to a computer program stored in a read only memory (ROM) 902 or a computer program loaded from a storage unit 908 to a random-access memory (RAM) 903. In the RAM 903, various programs and data required for an operation of the device 900 may also be stored. The computing unit 901, the ROM 902, and the RAM 903 are connected with each other through a bus 904. Input/output (I/O) interface 905 is also connected with the bus 804.

A plurality of components in the device 900 are connected with the I/O interface 905, including: an input unit 906, for example, a keyboard and a mouse, etc.; an output unit 907, for example, various types of displays and speakers, etc.; a storage unit 908, for example, a magnetic disk and an optical disk, etc.; and a communicating unit 909, for example, a network card, a modem, and a wireless communication transceiver, etc. The communicating unit 909 allows the device 900 to exchange information/data with other devices through a computer network such as the Internet and/or various telecommunication networks.

The computing unit 901 may be various general and/or dedicated processing components with processing and computing capabilities. Some examples of the computing unit 901 include, but are not limited to, a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 901 performs various methods and processes described above, for example, the update method of a face database and the face recognition method. For example, in some embodiments, the update method of the face database and the face recognition method may be implemented as a computer software program tangibly embodied in a machine readable medium, for example, the storage unit 908. In some embodiments, part or the entire computer program may be loaded and/or installed on the device 900 via the ROM 902 and/or the communicating unit 909. When the computer program is loaded into the RAM 903 and executed by the computing unit 901, one or more steps of the update method of the face database and the face recognition method described above may be performed. Alternatively, in other embodiments, the computing unit 901 may be configured to perform the update method of the face database and the face recognition method by any other appropriate manners (for example, by means of firmware).

Various embodiments of systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or combinations thereof. These various implementation manners may include: being implemented in one or more computer programs that may be executed and/or interpreted on a programmable system including at least one programmable processor which may be a dedicated or general programmable processor and may receive data and an instruction from a storage system, at least one input apparatus, and at least one output apparatus, and transmit the data and the instruction to the storage system, the at least one input apparatus, and the at least one output apparatus.

Program codes for implementing the method of the present disclosure may be written in any combination of one or more programming languages. These program codes may be provided to a processor or a controller of a general computer, a dedicated computer, or other programmable data processing apparatus, so that the program codes, when executed by the processor or the controller, enable functions/operations specified in a flowchart and/or a block diagram to be implemented. The program codes may be executed completely on a machine, partially on the machine, partially on the machine as an independent software package, and partially on a remote machine or completely on a remote machine or server.

In the context of the present disclosure, a machine readable medium may be a tangible medium that may contain or store a program for use by or in combination with an instruction execution system, apparatus or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any appropriate combination of the above. More specific examples of the machine readable storage medium may include an electrical connection based on one or more wires, a portable computer disk, a hard disk, a random-access memory (RAM), a read only memory (ROM), an erasable programmable read only memory (EPROM) or flash memory, an optical fiber, a portable compact disk read only memory (CD-ROM), an optical storage device, a magnetic storage device, or any appropriate combination of the above.

To provide interactions with a user, the systems and techniques described herein may be implemented on a computer having: a display apparatus (e.g., a CRT (cathode ray tube) or LCD (liquid crystal display) monitor) for displaying information to the user; and a keyboard and a pointing apparatus (e.g., a mouse or a trackball) through which the user may provide input to the computer. Other kinds of apparatuses may also be used to provide interactions with users; for example, a feedback provided to the user may be any form of sensory feedback (for example, a visual feedback, an auditory feedback, or a tactile feedback); and input from the user may be received in any form (including acoustic input, voice input, or tactile input).

The systems and technologies described herein may be implemented in a computing system including background components (e.g., as a data server), a computing system including middleware components (e.g., an application server), or a computing system including front-end components (e.g., a user computer with a graphical user interface or a web browser through which a user may interact with implementations of the systems and techniques described herein), or a computing system including any combination of such background components, middleware components, or front-end components. Components of the systems may be connected to each other through a digital data communication in any form or medium (e.g., communication network). An example of a communication network includes: a local area network (LAN), a wide area network (WAN), and the Internet.

A computer system may include a client and a server. The client and the server are generally remote from each other and usually interact through a communication network. A relationship between the client and the server is generated by a computer program running on a corresponding computer and having a client-server relationship with each other. The server may be a cloud server, also known as a cloud computing server or a cloud host, which is a host product in a cloud computing service system to solve defects of difficult management and weak traffic scalability in a conventional physical host and a VPS service (“Virtual Private Server”, or “VPS” for short). The server may also be a server of a distributed system or a server in combination with a blockchain.

It should be understood that steps may be reordered, added or deleted using various forms of flows shown above. For example, steps described in the present disclosure may be executed in parallel, sequentially, or in a different order, as long as a desired result of the technical solutions disclosed in the present disclosure can be achieved, which is not limited herein.

The above specific implementations do not limit protection scope of the present disclosure. It should be understood by persons skilled in the art that various modifications, combinations, subcombinations, and substitutions may be made according to design requirements and other factors. Any modification, equivalent substitution, and improvement made within spirit and principle of the present disclosure shall be included in the protection scope of the present disclosure.

What is claimed is:

1. An update method for a face database, comprising:
obtaining a face image set belonging to a same user as an obtained current face image in an original face database, wherein the face database comprises a face image set of at least one user, and the face image set comprises a stored face image;
determining similarity between the current face image and the stored face image of the same user, wherein there is a count value for the stored face image of the same user, and the count value represents a number of consecutive unsuccessful matches or consecutive successful matches between the stored face image of the same user and a further face image of the same user; and
updating the original face database according to the similarity and the count value to obtain an updated face database.

2. The method according to claim 1, wherein the updating the original face database according to the similarity and the count value to obtain the updated face database comprises:
updating the count value according to the similarity to obtain an updated count value, and updating the original face database according to the updated count value to obtain the updated face database.

3. The method according to claim 2, wherein when the count value represents the number of the consecutive unsuccessful matches, the updating the count value according to the similarity to obtain the updated count value comprises:
when the similarity is less than a preset similarity threshold, accumulating the count value to obtain the updated count value; and
when the similarity is greater than the similarity threshold, clearing the count value to obtain the updated count value.

4. The method according to claim 2, wherein when the count value represents the number of the consecutive unsuccessful matches; a number of the stored face image of the same user is multiple, and there is an updated count value for each stored face image of the same user; the updating the original face database according to the similarity and the count value to obtain the updated face database comprises:
determining a maximum updated count value from each updated count value; and
replacing a stored face image with the maximum updated count value with the current face image.

5. The method according to claim 3, wherein when the count value represents the number of the consecutive unsuccessful matches; a number of the stored face image of the same user is multiple, and there is an updated count value for each stored face image of the same user; the updating the original face database according to the similarity and the count value to obtain the updated face database comprises:
determining a maximum updated count value from each updated count value; and
replacing a stored face image with the maximum updated count value with the current face image.

6. The method according to claim 4, wherein the replacing the stored face image with the maximum updated count value with the current face image comprises:
when the maximum updated count value reaches a preset threshold of the consecutive unsuccessful matches, replacing the stored face image with the maximum updated count value with the current face image.

7. The method according to claim 5, wherein the replacing the stored face image with the maximum updated count value with the current face image comprises:
when the maximum updated count value reaches a preset threshold of the consecutive unsuccessful matches, replacing the stored face image with the maximum updated count value with the current face image.

8. The method according to claim 2, wherein when the count value represents the number of the consecutive successful matches, the updating the count value according to the similarity to obtain the updated count value comprises:
when the similarity reaches a preset similarity threshold, accumulating the count value to obtain the updated count value; and
when the similarity is less than the similarity threshold, clearing the count value to obtain the updated count value.

9. The method according to claim 2, wherein when the count value represents the number of the consecutive successful matches; a number of the stored face image of the same user is multiple, and there is an updated count value for each stored face image of the same user; the updating the original face database according to the similarity and the count value to obtain the updated face database comprises:
when there is an updated count value of zero, replacing a stored face image with the updated count value of zero with the current face image.

10. The method according to claim 8, wherein when the count value represents the number of the consecutive successful matches; a number of the stored face image of the same user is multiple, and there is an updated count value for each stored face image of the same user; the updating the original face database according to the similarity and the count value to obtain the updated face database comprises:
when there is an updated count value of zero, replacing a stored face image with the updated count value of zero with the current face image.

11. The method according to claim 9, wherein when there is a plurality of updated count value of zero, the replacing the stored face image with the updated count value of zero with the current face image comprises:
from the plurality of updated count values of zero, determining an updated count value of zero with a maximum number of clearing; and
replacing a stored face image with the updated count value of zero with the maximum number of the clearing with the current face image.

12. The method according to claim 10, wherein when there is a plurality of updated count value of zero, the replacing the stored face image with the updated count value of zero with the current face image comprises:
from the plurality of updated count values of zero, determining an updated count value of zero with a maximum number of clearing; and
replacing a stored face image with the updated count value of zero with the maximum number of the clearing with the current face image.

13. The method according to claim 1, wherein after obtaining, in the original face database, the face image set belonging to the same user as the obtained current face image, the method further comprises:
obtaining a total number of face images of the same user stored in the face database;
and the determining the similarity between the current face image and the stored face image of the same user comprises:
when the total number reaches a preset storage number threshold, determining the similarity between the current face image and the stored face image of the same user.

14. The method according to claim 2, wherein after obtaining, in the original face database, the face image set belonging to the same user as the obtained current face image, the method further comprises:
obtaining a total number of face images of the same user stored in the face database;
and the determining the similarity between the current face image and the stored face image of the same user comprises:
when the total number reaches a preset storage number threshold, determining the similarity between the current face image and the stored face image of the same user.

15. The method according to claim 13, further comprising:
when the total number does not reach the storage number threshold, adding the current face image to the face image set of the same user.

16. An update apparatus for a face database, comprising:
at least one processor; and
a memory communicably connected with the at least one processor; wherein,
the memory stores an instruction executable by the at least one processor, and the instruction is executed by the at least one processor to enable the at least one processor to:
obtain a face image set belonging to a same user as an obtained current face image in an original face database, wherein the face database comprises a face image set of at least one user, and the face image set comprises a stored face image;
determine similarity between the current face image and the stored face image of the same user, wherein there is a count value for the stored face image of the same user, and the count value represents a number of consecutive unsuccessful matches or consecutive successful matches between the stored face image of the same user and a further face image of the same user; and
update the original face database according to the similarity and the count value to obtain an updated face database.

17. A face recognition method, comprising:
obtaining a face image to be recognized; and
recognizing the face image to be recognized based on a face database to obtain a recognizing result, wherein the face database is obtained based on the method according to claim 1.

18. A face recognition apparatus, comprising:
at least one processor; and
a memory communicably connected with the at least one processor; wherein,
the memory stores an instruction executable by the at least one processor, and the instruction is executed by the at least one processor to enable the at least one processor to:
obtain a face image to be recognized; and
recognize the face image to be recognized based on a face database to obtain a recognizing result, wherein the face database is obtained based on the method according to claim 1.

19. A non-transitory computer readable storage medium storing a computer instruction, wherein the computer instruction is used to enable a computer to:
obtain a face image set belonging to a same user as an obtained current face image in an original face database, wherein the face database comprises a face image set of at least one user, and the face image set comprises a stored face image;
determine similarity between the current face image and the stored face image of the same user, wherein there is a count value for the stored face image of the same user, and the count value represents a number of consecutive unsuccessful matches or consecutive successful matches between the stored face image of the same user and a further face image of the same user; and
update the original face database according to the similarity and the count value to obtain an updated face database.

20. A non-transitory computer readable storage medium storing a computer instruction, wherein the computer instruction is used to enable a computer to execute the method according to claim 17.
